(19) United States
(12) Patent Application Publication
(10) Pub. No.: US 2020/0179861 A1
(43) Pub. Date: Jun. 11, 2020

(54) Cleaning system for bag filters

(71) Applicant: Christian Reining, Munster (DE)

(72) Inventor: Christian Reining, Munster (DE)

(21) Appl. No.: 16/221,929

(22) Filed: Dec. 17, 2018

(30) Foreign Application Priority Data
Dec. 7, 2018 (EP) 18000949.0

(51) Int. Cl. B01D 46/04; B08B 5/02; B08B 15/04; B01D 46/48; B08B 9/035

(52) U.S. Cl. CPC B01D 46/04; B08B 5/02; B01D 2273/28; B01D 46/48; B08B 9/035; B08B 15/04

(57) ABSTRACT

A cleaning device for bag filters, comprising a cleaning head which is connected via a pressure fluid hose to a pressure medium source and has a cleaning bore, which can be rotated about a main axis of the cleaning head around and exits through the pressure medium, and with a control device for controlling operating parameters, is characterized in that the cleaning head is connected via a drive shaft with a drive device which sets the cleaning bore in rotation, wherein the control device also controls the drive means.

### TECHNICAL FIELD

The present disclosure relates to a cleaning system for bag filters with a suction bell for a mobile cleaning device for pressure cleaning bag filters.

### BACKGROUND

Such a cleaning system is known, for example, from EP 2 409 788 A2 and such a cleaning device is known, for example from EP 1 543 872 A1 or EP 1 932 577 A1. The cleaning devices disclosed in the aforementioned prior art are used to clean bag filters. The contaminated raw side of such bag filters to be cleaned by cleaning devices of the prior art is outside of the bag filter and the clean side is inside the bag filter.

Thus, the contaminated air flows from the outside through the filter material of the bag filter inwards and is discharged there in parallel to a main axis of the bag filter. As contaminated air flows through the bag filter, the impurities of the air get caught in the filter material, so that the air leaving the filter material to the inside of the bag filter is clean. During operation, the outer surface of such a bag filter is therefore continuously enriched with impurities of the contaminated air. This means that permeability of the filter material is increasingly reduced and, thus, their filter performance as well. It is therefore necessary at predetermined time intervals to clean such bag filters to always ensure a good filter performance.

For this purpose, at predetermined intervals either during operation of the filter system or during a standstill, prior art discloses that a cleaning head has to be introduced into the interior of the bag filter, i.e. on the clean side. The cleaning head is connected with a pressure fluid source via a pressure pipe. Bag filters are either vertically hanging with an open end in an opening of a filter-floor on which, for example, the pressure fluid source can be placed, or are horizontally installed in a filter-wall. The pressure fluid source has a control device, with the aid of which the pressure of the pressure fluid is adjustable. The cleaning head in turn has at least one radial cleaning bore, from which the pressure fluid can emerge in the radial direction from the cleaning head to impinge on the inner surface of the respective bag filter. For non-rotating cleaning heads, the cleaning bore forms e.g. an annular nozzle, such that a circumferential cleaning jet can escape which, as the cleaning head moves along the longitudinal main axis of the bag filter, causes the filter material of the bag filter to bulge outside in the direction of movement. As a result, the filter material drops from the outer surface of the bag filter and is cleaned after a while of a cleaning operation.

In the above-mentioned prior art, the cleaning head also has at least one tangential bore, which does not serve to clean, but rather to drive the cleaning head or a component with the cleaning bore. Due to the at least one tangential bore, pressure fluid likewise exits tangentially and causes at least the cleaning bore to rotate. During a cleaning operation, the rotation causes the tangential cleaning jet emerging from the radial respective cleaning bore to helically move along the inside of the bag filter as the cleaning head reciprocates along the longitudinal axis of the bag filter. The pitch of the helix described thereby depends on the speed with which the cleaning head is moved along the longitudinal main axis of the bag filter. Rotating cleaning systems provide better cleaning performance over non-rotating cleaning systems.

The disadvantage of the rotary cleaning devices of the above-mentioned prior art is that the control of the pressure fluid and the control of the rotational movement of the cleaning bore are directly dependent on each other. At a low pressure of the pressure fluid, the rotational speed of the cleaning bore decreases and at a higher pressure, the rotational movement of the cleaning bore increases accordingly.

This dependency turns out to be a disadvantage when a cleaning device for bag filters is to be used for a wide range of applications. Depending on the nature of the contamination, it may be beneficial in one case to operate with higher pressure and less rotational movement, while in another case it may be beneficial to operate with low pressure and high rotational movement.

In a cleaning operation suction cups for a use for cleaning bag filters are known from the prior art. Suction devices are regularly positioned only in the vicinity of a bag filter opening to extract a dust fraction in the air which occurs there during the cleaning process. To this end, suction systems are used which are known from technical fields in which relatively large amounts of dust are regularly produced during material processing, which dust must be extracted. For example, such suction devices are known in wood processing. In a mobile use for bag filter cleaning, the free end of a suction bell is simply positioned in the vicinity of the bag filter opening.

The suction systems known from the prior art do not form a unit with a cleaning device during operation, as they are not physically connected to each other. In cleaning devices, rotating cleaning heads are generally used, which are difficult to handle when cleaning horizontally installed bag filters when there is no unit between the suction system and the cleaning device.

It is therefore the object of the present disclosure to develop a cleaning system with a cleaning device of the type mentioned above in such a way that it can always be optimally controlled in a wide range of applications.

### SUMMARY

The object is achieved in that the cleaning head is connected with a drive device via a drive shaft which causes the cleaning bore to move in rotation, wherein the control device also controls the drive means.

With the present disclosure, it is now possible to control the cleaning hole independently of the pressure fluid. The cleaning bore is driven by a drive shaft by means of a drive device and not by the pressure medium emerging from tangential bores.

Another advantage is that the cleaning head has a rotor in which the cleaning bore is formed. This measure ensures that not the entire cleaning head has to rotate, but only a component thereof. It is therefore possible to cover the rotor to the outside and thereby prevent rotating parts from colliding with a support head arranged between the cleaning head and the filter material.

A further advantage is that the pressure fluid hose is coupled to a pressure pipe at an end opposite the cleaning head. The arrangement of a pressure pipe between the pressure fluid hose and the pressure fluid source allows to easily connect mechanical components, e.g. for controlling the pressure fluid within the hose.

Another advantage is that the drive shaft is flexible. A flexible drive shaft makes it possible to arrange the drive device in spatial distance from the cleaning head and to guide the drive shaft in the pressure fluid hose. The flexible drive shaft can adapt to the movements of the pressure fluid hose.

Another advantage is that the pressure pipe has a bearing for the flexible drive shaft. The drive shaft can thus be introduced from the drive means via the bearing in the pressure tube.

### BRIEF DESCRIPTION OF THE DRAWINGS

FIG. 1 is a schematic representation of a positioned outside a bag filter control box as part of the cleaning device according to a first embodiment.

FIG. 2 shows a schematic illustration of a cleaning head and a pressure medium hose attached thereto as part of the cleaning device from FIG. 1.

FIG. 3 is a schematic representation of a cleaning head and an attached pressure fluid hose as part of the cleaning device in a second embodiment.

FIG. 4 shows a schematic view of a cleaning device, suction bell, and suction system.

FIG. 5 shows a perspective view of a suction bell with different lower bell parts.

FIG. 6 shows a perspective view of an upper bell part with a through-opening for a cleaning element with a felt seal.

### DETAILED DESCRIPTION

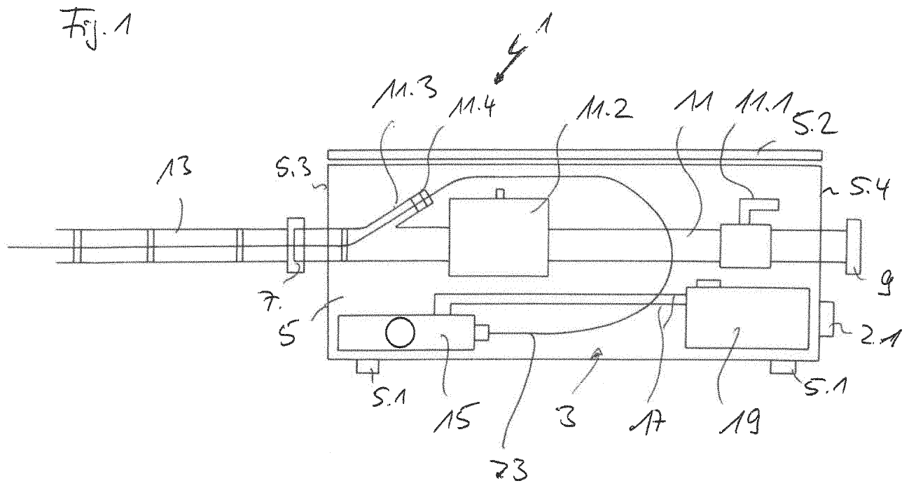

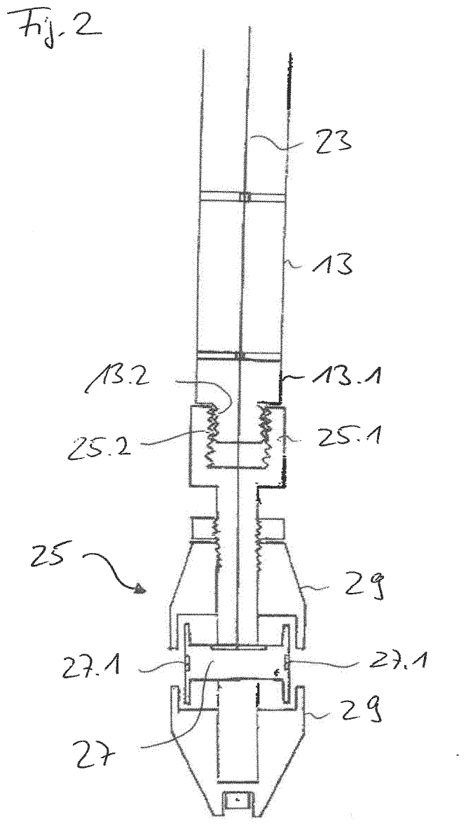

In FIG. 1, a part of a cleaning device 1 in a first embodiment is shown schematically. The part is referred to as a control box 3 and is positioned outside a filter hose (not shown) to be cleaned. For this purpose, the control box 3 on a housing 5, which is shown here only schematically as a rectangular line. On the housing 5 feet 5.1 are on the bottom side and cover 5.2 provided a cover. On a first side wall 5.3, the housing 5 has a first coupling connection 7. On a second side wall 5.4, the housing 5 has a second coupling connection 9. Inside the housing 5 there is a pressure tube ii, which extends from the coupling connection 7 to the second coupling connection 9 and, in the present first embodiment, extends essentially without curvature. The second coupling port 9 serves as a connection to a pressure medium source (not shown) and the first coupling port 7 serves to connect a pressure fluid hose 13. As a pressure medium source can serve for the present embodiment, for example, a compressor. In this case, the pressure medium is ambient air. In other embodiments, however, other gases suitable for purification, e.g. inert gases, to be used.

At the pressure medium pipe 11, a stopcock 11.1 is arranged in the vicinity of the second coupling connection 9. With this shut-off valve 11.1, one of the pressure medium source via the second pressure medium connection 9 flowing pressure medium can be shut off. Downstream in the direction of the first coupling port 7, a control valve 11.2 is arranged on the pressure medium pipe 11, which can open and close. Between the control valve 11.2 and the first coupling port 7, a pipe extension 11.3 is provided which has a sealing element 11.4 at a free end, which may be an oil seal in the present first embodiment.

Below the pressure medium tube 11, a drive device 15 is arranged in the control box 3. The drive device 15 is an electric motor in the present first embodiment. The electric motor is connected via an electrical connection 17 to a control device 19. The control device 19 is a control box with display (not shown), with the operating parameters of the drive means 15, for example, speeds can be adjusted. The control device 19 may also be connected to the control valve 11.2 in order to adjust the operating parameters of the pressure medium can. In other embodiments, independent control means for pressure medium and drive can be provided. The control device 19 is in turn connected via a voltage supply connection 21 to a voltage source, for example mains voltage.

The drive device 15 drives a drive shaft 23, which enters the pressure fluid hose 13 via the sealing device 11.4 or the tube extension 11.3. The pipe extension 11.3 and the sealing device 11.4 serve as bearings for the flexible drive shaft 23.

The pressure medium hose 13 is a flexible hose, which is usually used for the conduction of pressure medium, e.g. compressed air, is used. The pressure fluid hose 13 is connected to a cleaning head 25 at an opposite end 13. This is shown schematically in FIG. The length of the pressure medium hose 13 is dependent on the length of a bag filter to be cleaned.

The end 13.1 of the pressure medium hose 13 has an external thread 13.2, which meshes with an internal thread 25.2 of a lid 25.1. In this way, the cleaning head 25 can be screwed onto the end 13.1 of the pressure medium hose 13. The screw connection is firm but detachable and well suited for a reliable connection.

In the cleaning head 25, a rotor 27 is formed, which has at least one cleaning bore 27.1, which is oriented substantially radially and directs a cleaning jet of the pressure medium in the direction of an inner wall of the bag filter. The drive shaft 23 is connected to the rotor 27 and drives the rotor 27 and thus the cleaning bore 27.1 to a rotational movement when the drive means 15 is turned on. The rotor 27 is largely covered to the outside by a jacket 29 of the cleaning head 25, so that the rotating components of the cleaning head 25 are not exposed. As a result, a contact between the rotor 27 and a support arranged in the bag filter for clamping the bag filter support basket is prevented. In the present embodiment, a recess 30 is formed in the shell 29, which is aligned with the cleaning bore 27.1 when both are rectified. As a result, pulses can be generated with continuous pressure medium flow, which still improve the cleaning effect.

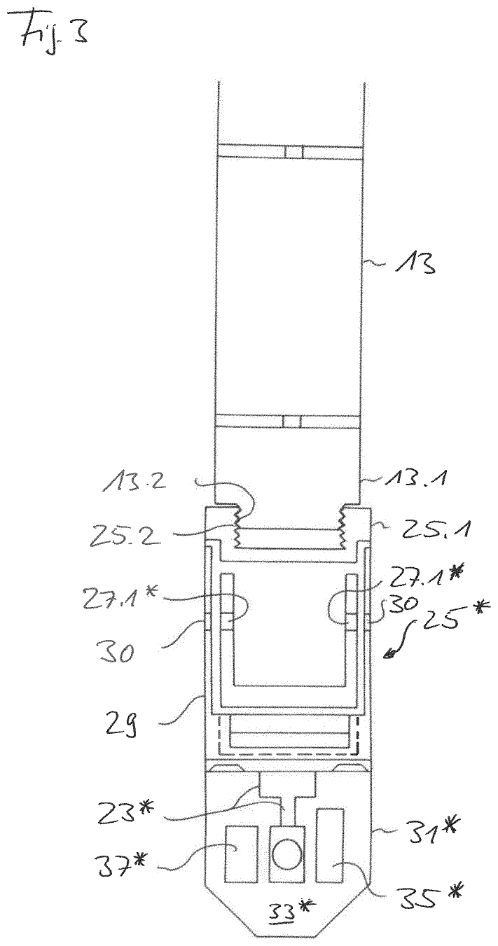

FIG. 3 shows a second embodiment of the cleaning device 1. The difference lies essentially only in the arrangement of the drive device. For this reason, the relevant components for the second embodiment are provided with the same reference numerals, which merely additionally have a “*”. The cleaning head 23* is identical to the cleaning head 23 in the components and structures not described.

In FIG. 3, the drive means 15* is arranged in the cleaning head 23*. This there replaces the drive device 15 in the control box 3. The pressure medium pipe 11 must then have no pipe extension 11.3 with the sealing device 11.4 in the second embodiment, at least this is then sealed by a closure (not shown). In the second embodiment, drive device 15* is integrated in the cleaning head 25*.

The cleaning head 25* in FIG. 3 has below the rotor 27* in a space 33* enclosed by an end cap 31* the drive device 15*, which is connected to the rotor 27* via the drive shaft 23*. The drive shaft 23* need not be flexible in the second embodiment, as in the first embodiment, but may also be rigid. As a voltage source 35* here is an accumulator. In the space 33* a controller 37* is arranged, with which the drive means 15* can be controlled. The drive device 15* is an electric motor. The controller 37* is connected via a radio link to the control device 19, so that the drive device 15* can be operated from the outside. Alternatively, wired connections between the controller 37* and the drive device 15* can be used.

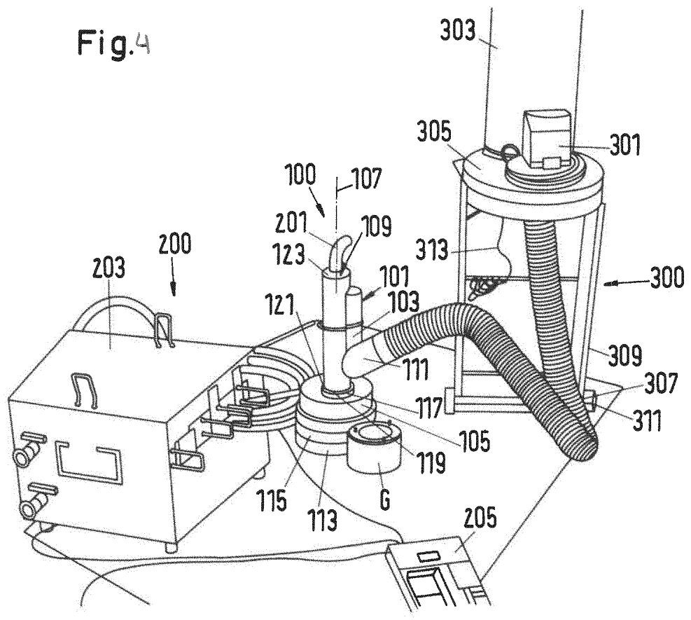

FIG. 4 schematically shows the cleaning system as a complete piece of cleaning equipment. The cleaning equipment comprises a suction bell 100, a suction system 200 and a cleaning device 300.

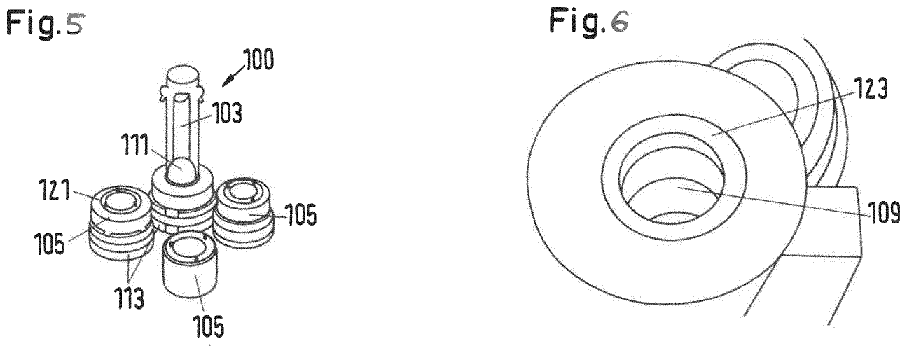

The suction bell 100 has a base body 101 which in the present embodiment is composed of an upper bell part 103 and a lower bell part 105. In other embodiments, the base body 101 can also be composed in one part or from any number of parts. The base body 101 has a longitudinal axis 107. A through-opening 109 runs through the base body 101 parallel to the longitudinal axis 107 and in the present embodiment also concentrically to the latter (see FIG. 6). The through-opening 109 runs through the entire base body 101, that is, both the upper bell part 103 and the lower bell part 105.

A connecting piece in for connecting the suction system 300 is formed laterally on the base body 101 and in the present embodiment on the upper bell part 103. The connecting piece 111 extends at an angle to the longitudinal axis 107, so that an acute angle is enclosed between the base body 101 or the upper bell part 103 and the connecting piece 111. It can be seen in FIG. 4 that the connecting piece 111 runs diagonally upwards in relation to the base body 101 when the suction bell wo is aligned in its operating function for cleaning a vertically installed bag filter. When the suction bell is arranged to clean a horizontally installed bag filter, the connecting piece 111 would point diagonally backwards.

A first felt seal 113 is applied to the base body 101 and in the present embodiment to the lower bell part 105. The first felt seal 113 completely surrounds the lower bell part 105. The first felt seal 113 is fixed for example by adhesive or else in an advantageous manner mechanically with the aid of a clamping element 115. The lower bell part 105 has a head plate 117 and the upper bell part 103 has a base plate 119 which abuts the head plate 117. A second felt seal 121 is attached between the head plate 117 and the base plate 119.

A third felt seal 123 is attached in the through-opening 109 (see FIG. 6). The third felt seal 123 surrounds the inner diameter of the through- opening 109 in an entry region for a cleaning element.

The lower bell part 105 is attached such that it can be replaced with respect to the upper bell part 103, for example by screw-fastening. FIG. 4 shows another lower bell part G which has a smaller outer diameter than the lower bell part 105. The suction bell 100 as a whole can be adapted to a different inner diameter of a bag filter by connecting different lower bell parts 105/G to the upper bell part 103. Further adaptation is possible if the thickness of the first felt seal 113 is varied.

FIG. 4 also shows the suction system 300. The suction system 300 comprises a conventional suction device with an electric motor 301 and a collection bag 303. A suction bag 307 is arranged between a housing 305, to which the electric motor 301 is attached, and the connecting piece 111 in of the suction bell 100. The suction bag 307 is flexible and can be stretched in length to a certain extent. The suction bag 307 is connected to the connecting piece 111 by usual connection elements, for example bag clamps. In the connected state the suction bell 100 forms a connection piece of the suction system 300 for connecting to a bag filter. The suction system 300 comprises wheels 311 on its housing 309 so that it is mobile. The suction system 300 also comprises an earth cable 313 with which static charge is prevented.

The cleaning equipment also comprises a cleaning device 200 with a cleaning element 201 which in the present case is a cleaning bag. In other embodiments, the cleaning element 201 can also be a fixed rod.

The cleaning bag 201 is flexible and connected to a control unit 203. The control unit 203 comprises a usual electric device for opening and closing a compressed air supply and for activating and deactivating the cleaning device and where necessary also the suction system 300.

A foot pedal 205 is provided for operating the control unit 203. The foot pedal 205 is connected to the control unit 203 via electric cables, the control unit 203 in turn being connected to the suction system 300 where necessary via electric cables (not shown). The compressed air supply can be switched on or off on the one hand and the cleaning device and/or the suction system can be activated or deactivated on the other hand by actuating the foot pedal 205. Of course, the control unit can also comprise a multiplicity of other functions which can at least partially be switched on or off by means of the foot pedal 205. The control technology is state of the art and does not form the subject matter of the present invention. A cleaning head (not shown) with at least one cleaning nozzle is attached to a free end of the cleaning element 201. In the present embodiment, the cleaning head or the at least one cleaning nozzle should rotate during operation. Of course, non-rotating cleaning heads or cleaning nozzles can also be used in other embodiments.

FIG. 5 schematically shows the suction bell 200 with different lower bell parts 105. FIG. 6 schematically shows how the third felt seal 123 is arranged in the region of the entry of the cleaning bag 201 on the inner circumference of the through-opening 109 of the upper bell part 103 or base body 101. By varying the thickness of the felt seal 123 it is possible to produce a seal with respect to cleaning elements 201 of differing thickness. FIG. 5 also clearly shows the second felt seal 121.

For a cleaning process, the suction system 300 is connected to the suction bell 100 and to the cleaning device 200. The mobile suction system 300 according to the invention has a maximum volumetric flow of 1100 m³/h at a pressure of 1750 Pa. Residual dust from the filter bags is not released but extracted. The cleaning bags 201 are designed for a pressure of up to 20 bar. There is a maximum temperature resistance of 180° C. Cleaning of filter systems in the high-temperature range in N-1 operation (without stopping) is thus also possible. The compressed air bags have a steel mesh liner and are additionally earthed by means of earth cables. Earthing is thus provided here too to prevent static charge and sparks. The control unit 203 has a foot pedal 205 for each cleaning head (not shown) and thus each suction system 300.

To carry out cleaning, the cleaning element 201 of the cleaning device 200 is introduced through the suction bell and the bag filter opening into the bag filter. The control unit 203 is then activated and the cleaning element 201 is moved in the bag filter, for example moved back and forth. After the cleaning process is finished, the control unit 203 is deactivated, for example by means of the foot pedal 205. The cleaning element 201 is then pulled out of the bag filter. The suction system 300 is then removed from the bag filter by pulling the suction cap 100 out of the bag filter opening.

When cleaning horizontally or vertically installed bag filters, cleaning elements with rotary nozzles are used in the present embodiment. Rotary nozzles are generally known from the prior art and do not form part of the present invention.

### LIST OF REFERENCE SYMBOLS

1 cleaning device

3 control box

5 housing

5.1 feet

5.2 cover

5.3 first side wall

5.4 second side wall

7 first coupling connection

9 second coupling connection

11 pressure medium pipe

11.1 stopcock

11.2 control valve

11.3 pipe extension

11.4 sealing element

13 pressure medium hose

13.1 End of the pressure medium hose

13.2 external thread

15 driving means

15* driving device

17 electrical connection

19 control device

21 Power Supply Connector

23 flexible drive shaft

23* drive shaft

25 cleaning head

25* cleaning head

25.1 cover

25.2 internal thread

27 rotor

27* rotor

27.1 cleaning hole

27.1* cleaning hole

29 coat

30 recess

31* end cap

33* space

35* voltage source

37* regulator

100 Suction bell

101 Base body

103 Upper bell part

105 Lower bell part

107 Longitudinal axis

109 Through-opening

111 Connecting piece

113 First felt seal

115 Clamping element

117 Head plate

119 Base plate

121 Second felt seal

123 Third felt seal

G Lower bell part

200 Cleaning device

201 Cleaning element

203 Control unit

205 Foot pedal

300 Suction system

301 Electric motor

303 Collection bag

305 Housing

307 Suction bag

309 Housing

311 Wheels

313 Earth cable

What is claimed is:

1. A cleaning system for bag filters, comprising:
a cleaning device;
a cleaning head connected to a pressure medium source via a pressure medium hose and connected to a drive device via a drive shaft,
wherein the drive device causes a cleaning bore to rotate around a main axis of the cleaning head while a pressure medium supplied by the pressure medium source exits the cleaning head through the cleaning bore; and
a control device operatively connected to the pressure medium source and to the drive device which controls operating parameters of both the pressure medium source and the drive device.

2. The cleaning system according to claim 1, wherein the cleaning head comprises a rotor in which the cleaning bore is formed.

3. The cleaning system according to claim 1, wherein the pressure medium hose is coupled to a pressure tube at an end opposite the cleaning head.

4. The cleaning system according to claim 3, wherein the drive shaft is flexible.

5. The cleaning system according to claim 3, wherein the pressure tube has a bearing for the drive shaft.

6. The cleaning system according to claim 3, wherein in that the pressure tube, the drive device and the control device are arranged in a housing.

7. The cleaning system according to claim 6, wherein the housing has a first coupling connection for coupling with the pressure medium hose and a second coupling connection for coupling with the pressure medium source.

8. The cleaning system according to claim 1, wherein the control device is connected to a power supply.

9. The cleaning system according to claim 7, wherein the housing has an electrical connection for supplying power to the control device.

10. The cleaning system according to claim 3, wherein the pressure tube has a control valve.

11. The cleaning system for bag filters according to claim 1, wherein the cleaning system includes a suction bell for a mobile cleaning device for pressure cleaning bag filters, with a housing and with a base body which has a connecting piece and an outer circumference adapted to an inner circumference of a filter opening and having a longitudinal axis.
